(19) United States
(12) Patent Application Publication
(10) Pub. No.: US 2023/0087271 A1
(43) Pub. Date: Mar. 23, 2023

(54) Frying Pan Device with Repositionable Handle

(71) Applicant: Vincent Lanteri, JR., Newport, NC (US)

(72) Inventor: Vincent Lanteri, JR., Newport, NC (US)

(21) Appl. No.: 17/578,811

(22) Filed: Jan. 19, 2022

Related U.S. Application Data
(60) Provisional application No. 63/246,359, filed on Sep. 21, 2021.

(51) Int. Cl. A47J 45/06; A47J 37/10

(52) U.S. Cl. CPC A47J 45/061; A47J 37/108

(57) ABSTRACT

The present invention relates to a frying pan device with adjustable handle. The device is primarily comprised of at least one pan body further comprised of at least one handle that has at least one hinge member, at least one main body member and at least one secondary body member. The hinge member is further comprised of at least one hinge that allows the handle to be repositioned such that it is vertical. The movement of the hinge may be controlled by at least one button. Further, the secondary body member is repositionable along the main body member. As a result, the secondary body member can be moved to allow the handle to expand and shorten in length.

### CROSS-REFERENCE TO RELATED APPLICATION

The present application claims priority to, and the benefit of, U.S. Provisional Application No. 63/246,359, which was filed on Sep. 21, 2021, and is incorporated herein by reference in its entirety.

### FIELD OF THE INVENTION

The present invention relates generally to the field of pans. More specifically, the present invention relates to a frying pan device with adjustable handle. The device is primarily comprised of at least one pan body further comprised of at least one handle that has at least one hinge member, at least one main body member and at least one secondary body member. The hinge member is further comprised of at least one hinge that allows the handle to be repositioned such that it is vertical. The movement of the hinge may be controlled by at least one button. Further, the secondary body member is repositionable along the main body member. As a result, the secondary body member can be moved to allow the handle to expand and shorten in length. Accordingly, the present disclosure makes specific reference thereto. Nonetheless, it is to be appreciated that aspects of the present invention are also equally applicable to other like applications, devices and methods of manufacture.

### BACKGROUND

Professional and amateur chefs alike use frying pans daily in their food preparation process. However, traditional pans can be exceedingly burdensome to clean and store neatly, as many large pans do not fit properly in household dishwashers or sinks. This is because said dishwasher or sinks are simply not wide or long enough to accommodate a flat pan and the pan handle simultaneously. When attempting to wash said pans, most of the water and dishwashing liquid ends up spilling out of the sink onto the counter and floor because the pan cannot completely fit in the sink. This in turn makes for an incredibly hazardous floor surface. Some individuals may attempt to circumvent this issue by installing larger sinks. However, this solution is cost-prohibitive for most users. In addition, larger sinks are prone to cracking existing countertops, especially granite or quartz countertop surfaces. Further, traditional frying pans also take up an undesirable amount of cupboard space because of their handles, even when stacked. This wastes potential storage area for other pots, pans, lids, colanders, strainers, cookie trays, and other items of the like.

Therefore, there exists a long-felt need in the art for an improved cooking pan. There also exists a long-felt need in the art for a frying pan device with adjustable handle that can be easily washed in a sink or dishwasher that is of normal size. Further, there exists a long-felt need in the art for a frying pan device with adjustable handle that can be easily stored and takes up less physical space than existing frying pans of the like.

The subject matter disclosed and claimed herein, in one embodiment thereof, comprises a frying pan device with adjustable handle. The device is primarily comprised of at least one pan body further comprised of at least one handle that has at least one hinge member, at least one main body member, and at least one secondary body member. The hinge member is further comprised of at least one hinge that allows the handle to be repositioned such that it is vertical. The movement of the hinge may be controlled by at least one button. Further, the secondary body member is repositionable along the main body member. As a result, the secondary body member can be moved to allow the handle to expand and shorten in length.

In this manner, the frying pan device with adjustable handle of the present invention accomplishes all of the forgoing objectives and provides an improved cooking pan with an adjustable handle that can be easily washed in a sink or dishwasher that is of normal size. Further, the device can be easily stored and takes up less physical space than existing frying pans of the like. As a result, the frying pan device with adjustable handle overcomes the limitations of existing frying pans and other pans of the like known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a frying pan device with adjustable handle. The device is primarily comprised of at least one pan body further comprised of at least one handle that has at least one hinge member, at least one main body member, and at least one secondary body member. The handle is preferably manufactured from a rigid plastic, a wood material, or any metal known in the art, wherein said metal preferably has low heat-conducting properties. The pan body is further preferably manufactured from a material such as, but is not limited to: aluminum, stainless steel, cast-iron, copper, carbon steel, enameled cast iron, glass, etc. The pan body is also preferably round in shape and is further comprised of a top surface that is preferably non-stick, a side surface, an interior surface that is preferably non-stick, and a bottom surface.

The handle is further comprised of a main body member and a secondary body member, wherein the main body member attaches to the side surface of a pan body via at least one hinge member that is fixedly or removably attached to the side surface of the pan body. The hinge member is comprised of a first hinge-member that is connected to at least one hinge. The other side of the hinge (i.e., the side that is not connected to the first hinge-member) is fixedly or removably connected to the first end of the main body member. In this manner, the hinge allows the main body member (and secondary body member which is attached to the second end of the main body member) to articulate from a horizontal position to a vertical position. In this manner, the handle can be positioned vertically such that it takes up much less space when being stored when not in use, or while being washed in a sink or dishwasher.

In order to move the secondary body member on the main body member to make the handle longer or shorter, a user can simply apply pressure (i.e., squeeze) the secondary body member and slide the secondary body member to the desired position on the main body to achieve the desired handle length. Then, the user can release the pressure on the secondary body member to secure it in said position. The main body and/or the secondary body may further be comprised of at least one spring. In one embodiment, the secondary body member is hollow and is comprised of at least one internal spring such that releasing pressure on the secondary body member releases pressure on the spring which in turn automatically telescopes the secondary body member to the end of the main body to give the handle its longest configuration. In an embodiment where the main body is hollow, the main body may also be comprised of at least one internal spring that is connected to the hinge. As a result, pressing at least one button located on the main body allows the hinge to become movable such that the main body and secondary body can be repositioned as noted above.

Accordingly, the frying pan device with adjustable handle of the present invention is particularly advantageous as it has an adjustable handle that allows the device to be easily washed in a sink or dishwasher that is of normal size. Further, the device can be easily stored and takes up less physical space than existing frying pans of the like. In this manner, the frying pan device with adjustable handle overcomes the limitations of existing frying pans and other pans of the like known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a frying pan device with adjustable handle of the present invention in accordance with the disclosed architecture;

FIG. 2 illustrates an enhanced perspective view of one potential embodiment of a frying pan device with adjustable handle of the present invention in accordance with the disclosed architecture; and

FIG. 3 illustrates an enhanced perspective view of one potential embodiment of a frying pan device with adjustable handle of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved cooking pan. There also exists a long-felt need in the art for a frying pan device with adjustable handle that can be easily washed in a sink or dishwasher that is of normal size. Further, there exists a long-felt need in the art for a frying pan device with adjustable handle that can be easily stored and takes up less physical space than existing frying pans of the like.

The present invention, in one exemplary embodiment, is comprised of a frying pan device with adjustable handle. The device is primarily comprised of at least one pan body further comprised of at least one handle that has at least one hinge member, at least one main body member, and at least one secondary body member. The hinge member is further comprised of at least one hinge that allows the handle to be repositioned such that it is vertical. Further, the movement of the hinge may be controlled by at least one button. In addition, the secondary body member is repositionable along the main body member. As a result, the secondary body member can be moved to allow the handle to expand and shorten in length. As a result, the adjustable handle allows the device to be easily washed in a sink or dishwasher that is of normal size. Further, the device can be easily stored and takes up less physical space than existing frying pans of the like.

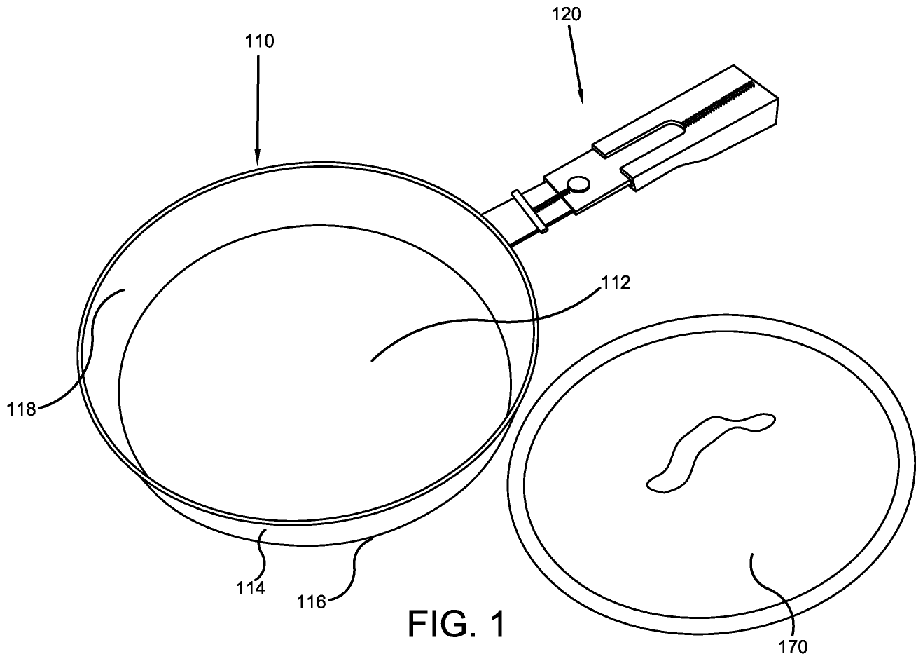

Referring initially to the drawings, FIG. 1 illustrates a perspective view of one potential embodiment of a frying pan device with adjustable handle 100 of the present invention in accordance with the disclosed architecture. The device 100 is primarily comprised of at least one pan body 110 further comprised of at least one handle 120 that has at least one hinge member 150, at least one main body member 130, and at least one secondary body member 140. The handle 120 is preferably manufactured from a rigid plastic material such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. The handle 120 may also be manufactured from a wood material, glass material, or any metal known in the art that, wherein said metal preferably has low heat-conducting properties. The pan body 110 is further preferably manufactured from a material such as, but is not limited to: aluminum, stainless steel, cast-iron, copper, carbon steel, enameled cast iron, glass, etc. The pan body 110 is also preferably round in shape but may be any shape, size, thickness, and/or dimension known in the art such as, but not limited to: square, rectangular, etc. The pan body 110 is further comprised of a top surface 112 that is preferably non-stick, a side surface 114, an interior surface 118 that is preferably non-stick, and a bottom surface 116.

The handle 120 is comprised of a main body member 130 and a secondary body member 140, wherein both members 130, 140 may be generally cylindrical, rectangular, or any shape, size, and/or thickness known in the art. Both members 130, 140 may also be textured for grip-purposes. The main body member 130 attaches to the side surface 114 of a pan body 110 via at least one hinge member 150 that is fixedly or removably attached to the side surface 114. The hinge member 150 is comprised of a first hinge-member 152 that is connected to at least one hinge 154. The at least one hinge 154 may be any hinge-type known in the art, such as but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The other side of the hinge 154 (i.e., the side that is not connected to the first hinge-member 152) is fixedly or removably connected to the first end 1300 of the main body member 130.

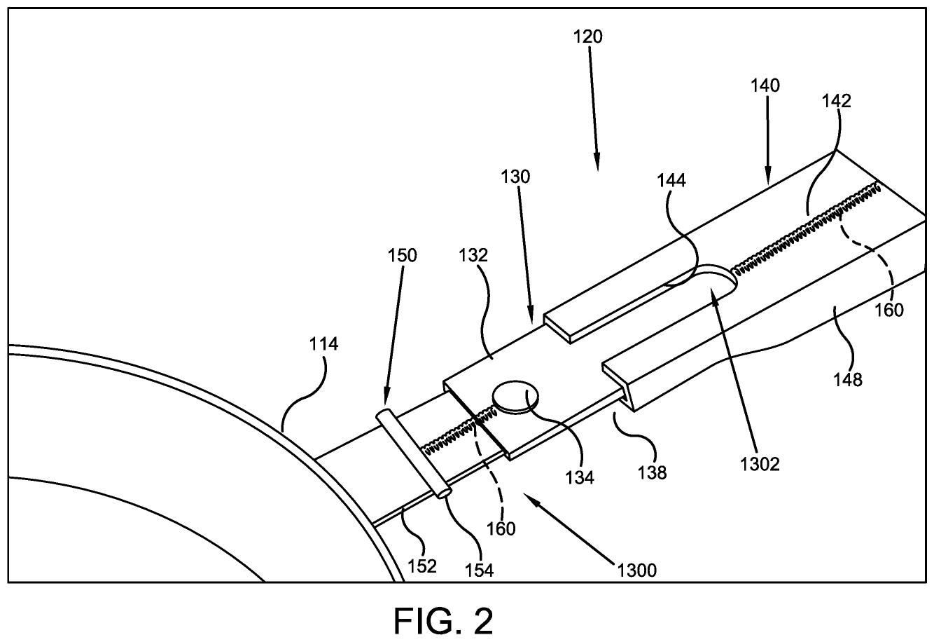

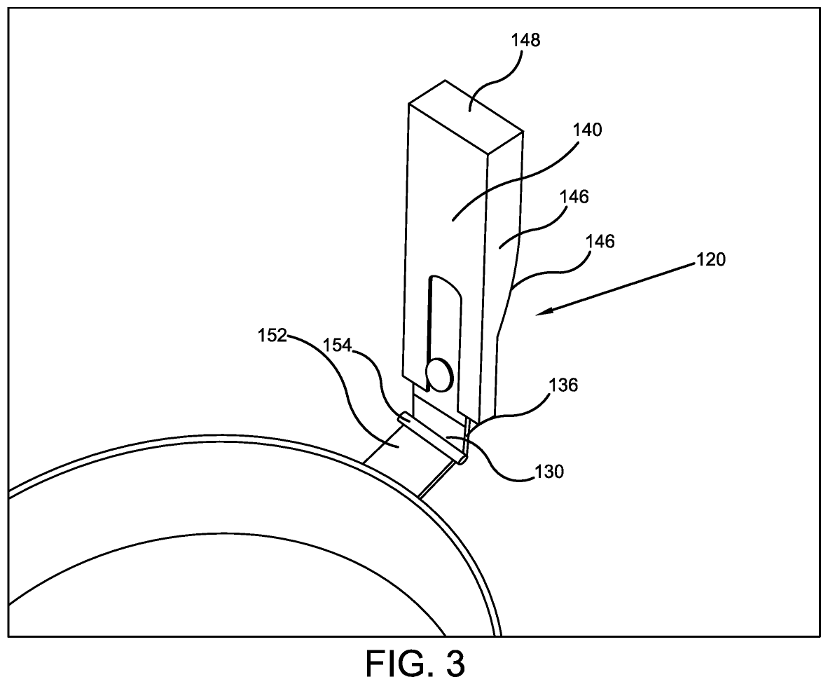

In this manner, the hinge 154 allows the main body member 130 (and secondary body member 140 which is attached to the second end 1302 of the main body member 130) to articulate from a horizontal position (shown in FIG. 1 and FIG. 2) to a vertical position (shown in FIG. 3), wherein said position is preferably at a 90-degree angle in relation to the first hinge member 152. In this manner, the handle 120 can be positioned vertically such that it takes up much less space when being stored when not in use, or while being washed in a sink or dishwasher.

The main body 130 is further comprised of a top surface 132, a bottom surface 136, and at least one pair of side surfaces 138. The secondary body member 140 further fits over the main body member 130, wherein the secondary body member 140 is further comprised of a top surface 142 with a cutout 144, a bottom surface 146, and at least one pair of side surfaces 148. The secondary body member 140 is telescoping such that it can change position on the main body member 130 to make the entire handle 120 longer or shorter. In this manner, the handle 120 can be more easily stored, or washed within a sink or dishwasher.

In order to move the secondary body member 140 relative to or along the main body member 130 to make the handle 120 longer or shorter, a user can simply apply pressure (i.e., squeeze) the secondary body member 140 and slide the secondary body member 140 to the desired position along a shared longitudinal axis with the main body 130 to achieve the desired overall handle 120 length. Then, the user can release the pressure on the secondary body member 140 to secure it in said position. The main body member 130 and/or the secondary body member 140 may further be comprised of at least one spring 160. In one embodiment, the secondary body member 140 is hollow and is comprised of at least one internal spring 160 such that releasing pressure on the secondary body member 140 releases pressure on the spring 160 which in turn automatically telescopes the secondary body member 140 to the end of the main body member 130 to give the handle 120 its longest configuration.

In an embodiment where the main body member 130 is hollow, the main body member 130 may also be comprised of at least one internal spring 160 that is connected to the hinge 154. As a result, pressing the button 134 located on the main body member 130 allows the hinge 154 to become movable such that the main body member 130 and the secondary body member 140 can be repositioned as noted above. In an additional embodiment, the button 134 may also be used to automatically telescope the secondary body member 140 to the end of the main body member 130 to give the handle 120 its longest configuration. Further, the cutout 144 of the secondary body member 140 ensures that the button 134 is not obstructed by the secondary body member 140 when the handle 120 is in its smallest configuration (i.e., wherein the secondary body member 140 covers the largest amount of the main body member 130). When the button 134 is not pressed, the hinge 154 is further immovable. Likewise, in an embodiment where the button 134 may also be used to automatically telescope the secondary body member 140 to the end of the main body member 130, the secondary body member 140 may be immovable until the button 134 is pressed.

It should be appreciated that in any embodiment of the device 100, the pan body 110 may be any size, shape, style and type of pan, pot, bowl, or other cooking vessel of the like. In this manner, the device 100 is not limited to a frying pan ban body 110. Further, the handle 120 may be any length, and differing embodiments of the device 100 may have main body members 130 and secondary body members 140 of equal or differing lengths which in turn can produce handles 120 of differing lengths in differing embodiments. In one embodiment, the body 110 may also be comprised of a removable lid 170 made of the same or differing material as the pan body 110.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “frying pan device with adjustable handle” and “device” are interchangeable and refer to the frying pan device with adjustable handle 100 of the present invention.

Notwithstanding the forgoing, the frying pan device with adjustable handle 100 of the present invention and its various components can be of any suitable size and configuration as is known in the art without affecting the overall concept of the invention, provided that they accomplish the above-stated objectives. One of ordinary skill in the art will appreciate that the size, configuration and material of the frying pan device with adjustable handle 100 as shown in the FIGS. are for illustrative purposes only, and that many other sizes and shapes of the frying pan device with adjustable handle 100 are well within the scope of the present disclosure. Although the dimensions of the frying pan device with adjustable handle 100 are important design parameters for user convenience, the frying pan device with adjustable handle 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pan device comprising:
a pan body; and
a handle comprised of a spring, main body member, a secondary body member and a hinge member that attaches to the main body member, wherein the hinge member is comprised of a hinge.

2. The pan device of claim 1, wherein the handle can be articulated from a horizontal position to a vertical position.

3. The pan device of claim 2 further comprising a button that when pressed allows the handle to be articulated from the horizontal position to the vertical position.

4. The pan device of claim 1, wherein the secondary body member is repositionable relative to the main body member.

5. The pan device of claim 4, wherein the repositioning of the secondary body member make the handle longer or shorter in length.

6. The pan device of claim 1, wherein the pan body is a frying pan.

7. The pan device of claim 6, wherein the pan body comprises a non-stick top surface and a non-stick interior surface.

8. A pan device comprising:
a pan body; and
a handle comprised of a main body member, a secondary body member that is repositionable relative to the main body member, a hinge member attached to the main body member and a spring, wherein the hinge member is comprised of a hinge that allows the main body member to articulate.

9. The pan device of claim 8 further comprised of a button that when pressed allows the handle to be rotated between a horizontal position and a vertical position.

10. The pan device of claim 8, wherein the secondary body member is repositionable along a longitudinal axis shared with the main body member.

11. The pan device of claim 10, wherein the secondary body can be repositioned relative to the main body member to make the handle longer or shorter in length.

12. The pan device of claim 8, wherein the pan body is a frying pan.

13. The pan device of claim 12, wherein the pan body comprises a non-stick top surface and a non-stick interior surface.

14. A frying pan and adjustable handle device comprising:
a pan body;
a handle comprised of a spring, main body member, a secondary body member that is repositionable along the main body member, a hinge member that attaches to the main body member, wherein the hinge member is further comprised of a hinge that allows the main body member to articulate; and
a lid.

15. The frying pan and adjustable handle device of claim 14 further comprising a button that when pressed allows the handle to be rotated between a horizontal position and a vertical position.

16. The frying pan and adjustable handle device of claim 14, wherein the repositioning of the secondary body member along the main body member occurs on a shared longitudinal axis.

17. The frying pan and adjustable handle device of claim 16, wherein the secondary body can be repositioned to make the handle longer or shorter in length.

18. The frying pan and adjustable handle device of claim 14, wherein hinge is a select one of an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge and a locking hinge.

19. The frying pan and adjustable handle device of claim 18, wherein the pan body comprises a non-stick top surface and a non-stick interior surface.

20. The frying pan and adjustable handle device of claim 14, wherein the handle is manufactured from a plastic, a wood or a metal.
